(19) United States
(12) Patent Application Publication
(10) Pub. No.: US 2005/0019723 A1
(43) Pub. Date: Jan. 27, 2005

(54) Fixing pin for model teeth die

(76) Inventors: Dae-Woong Kim, Anyang-si (KR); Won-Chul Lee, Gaganna, OH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/658,672

(22) Filed: Sep. 9, 2003

(30) Foreign Application Priority Data
Jul. 24, 2003 (KR) 10-2003-0050854

(51) Int. Cl. A61C 19/00

(52) U.S. Cl. 433/74

(57) ABSTRACT

Disclosed is a fixing pin for a model teeth die connecting a model teeth die to a model base. The fixing pin includes a model base inserting portion having a side expansion portion and being inserted into the model base, and a die inserting portion being fixedly inserted into the model teeth die. The model base inserting portion is a taper type, and the side expansion portion is a streamline and expands from one side of the model base inserting portion. Further, the die inserting portion is formed on the upper surface of the model base inserting portion neighboring to the side expansion portion. Thereby, when the model teeth die is connected to the model base, it is prevented from being rotated. Further, the fixing pin may be easily manufactured.

### RELATED APPLICATION

This application claims priority under 35 U.S.C. § 119 or 365 to Korean Application No. 10-2003-0050854, filed Jul. 24, 2003. The entire teachings of the above application are incorporated herein by reference.

### TECHNICAL FIELD

The present invention relates to a fixing pin. More particularly, the present invention relates to a fixing pin for model teeth die including a model base inserting portion and a die inserting portion formed on the upper surface of the model base inserting portion, whereby a model teeth die is prevented from being rotated when being connected to a model base and can be easily connected to and disconnected from the model base.

### BACKGROUND ART

Generally, if teeth of a person are rotten or have abnormality, they are changed with new artificial teeth or covered with dental prostheses after being remedied.

To process the dental prostheses, firstly the teeth of a person are cut out as a pattern. Afterwards, a proper material such as plaster is inserted into the pattern, and thereby the model teeth die having the same shape as the real teeth is manufactured. Next, each manufactured teeth die is mounted on a model base corresponding to the gums of a person and manufactured to have the same structure as the real teeth. Afterwards, the model teeth are mounted on an articulator and simulated a motion such as mastication, thereafter it is observed whether the dental prostheses fit into the real teeth.

In this process, if the model teeth dies do not properly accomplish a mastication motion, the corresponding model teeth die is disconnected from the model base. Afterwards, the model teeth die is worked again and mounted on the model base, and then simulated a motion such as mastication repeatedly. Finally, a dental prosthesis enabling to fit into the real teeth is manufactured.

At this time, the task in which the model teeth die is connected to and disconnected from the model base is done repeatedly, and a fixing pin for model teeth die is used to connect the model teeth die to the model base.

At the present time, diverse types of fixing pins for model teeth die are produced and used. For example, Korean Registered Utility Model No. 20-0263353 discloses “Fixing pin for model teeth die provided with a cylinder with an easy usage”.

The fixing pin for model teeth die, as shown in FIG. 5, includes a fixing pin 200 having a guide pin 203, a slanted pin 204 and a connecting portion 202, and a cylinder 300 having a connecting essential part 301 where the fixing pin 200 is inserted.

The connecting portion 202 of the fixing pin 200 is mounted on the lower surface of the model teeth die 100, and the cylinder 300 is inserted into a model base (not shown). Thereby, the model teeth die 100 is easily connected to and disconnected from the model base, and the model teeth die or the model base is not damaged although the model teeth die is repeatedly connected to and disconnected from the model base.

However, the fixing pin for model teeth die should include the fixing pin and the cylinder, which are made of a metallic material, and the fixing pin should have two pins, that is the slanted pin and the guide pin, in order to prevent from being rotated.

Therefore, the processing for the fixing pin for model teeth die is troublesome. Further, the fixing pin and the cylinder should be made of a metallic material, therefore it requires high manufacturing cost.

Further, when a technician works the fixing pin, he/she should hold it with one hand and should rotate it with the other hand in order to work the model teeth part. However, since the fixing pin is a dual type, the above task is difficult to be accomplished.

### DISCLOSURE OF INVENTION

Therefore, the present invention has been developed to solve the above-mentioned problems. It is an object of the present invention to provide a fixing pin for a model teeth die in which a taper typed model base inserting portion having a side expansion portion and a die inserting portion are formed integrally, and in which the model teeth die is prevented from being rotated when it is connected to the model base, in which it is worked easily, and in which the model teeth die is easily connected to and disconnected from the model base.

In order to achieve the above object of the present invention, the present invention provides a fixing pin comprising a model base inserting portion for preventing a model teeth die from being rotated and for connecting the model teeth die to a model base, and a die inserting portion connected to the model base inserting portion and connecting to the model teeth die.

In the fixing pin for a model teeth die according to a preferred embodiment of the present invention, the model base inserting portion may be formed with more than one side expansion portion on the outer periphery surface thereof.

Further, the model base inserting portion may be formed with more than a pair of side expansion portions being opposite to each other on the outer periphery surface thereof.

Thereby, the model teeth die is prevented from being rotated when it is connected to the model base.

Further, the expansion portion is formed to be in a streamline type, thereby the model teeth die may be easily connected to and disconnected from the model base.

Further, the model base inserting portion and the die inserting portion are made of plastic materials, thereby the manufacturing cost can be saved.

Further, the model base inserting portion and the die inserting portion are formed to be eccentric, thereby they further prevent the model teeth die from being rotated when it is connected to the model base.

Further, the model base inserting portion is formed in taper type, thereby a technician may easily rotate the model teeth die.

### BRIEF DESCRIPTION OF THE DRAWINGS

Other features and advantages of the present invention will become more apparent from the following description taken in connection with the accompanying drawings, wherein:

FIG. 1 is a schematic overall perspective view showing a state in which a model teeth die is connected to a model base by a fixing pin for a model teeth die according to a preferred embodiment of the present invention;

FIG. 2 is a schematic overall perspective view showing the fixing pin for a model teeth die, the model teeth die and the model base in FIG. 1;

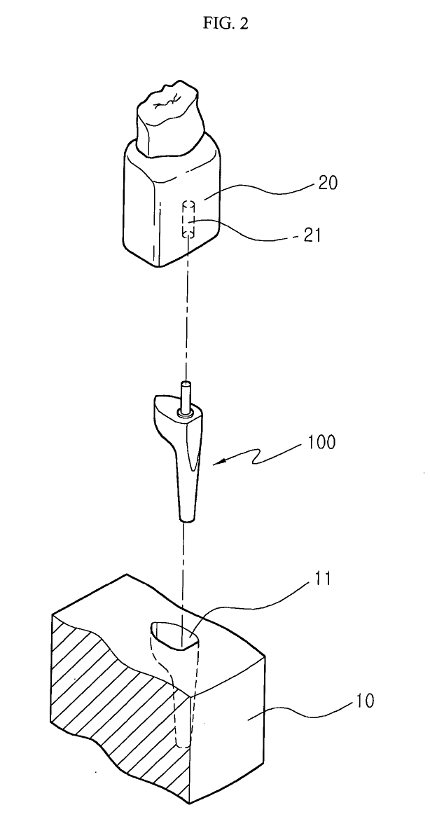

FIG. 3 is an overall perspective view of the fixing pin for a model teeth die in FIG. 1;

FIG. 4 is an overall perspective view of the fixing pin for a model teeth die according to another preferred embodiment of the present invention; and

FIG. 5 is a schematic overall perspective view showing the fixing pin for a model teeth die.

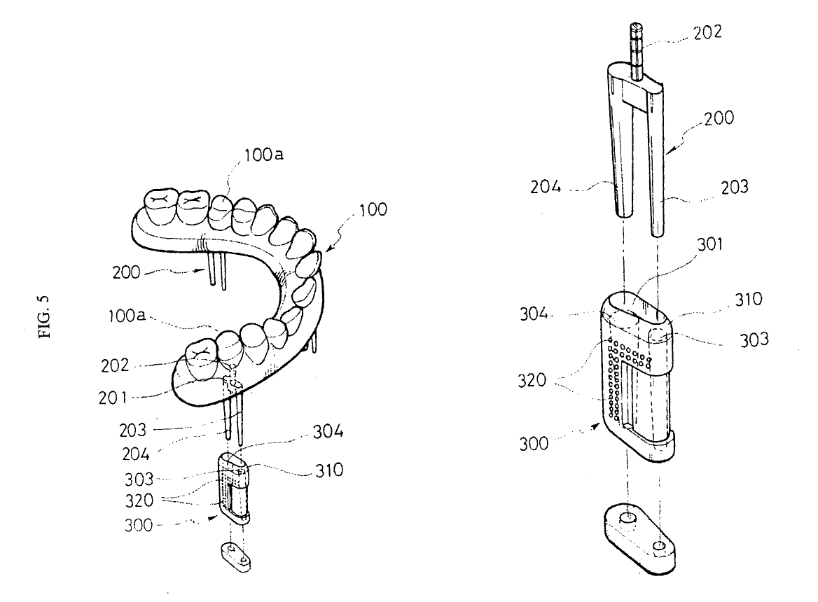

### DESCRIPTION OF THE PREFERRED EMBODIMENTS

Hereinafter, the fixing pin for a model teeth die according to the preferred embodiments of the present invention will be explained in detail referring to accompanying drawings.

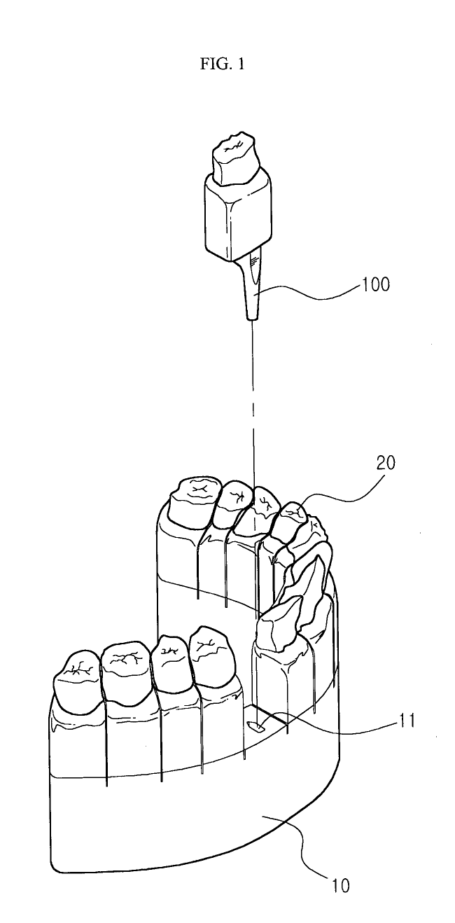

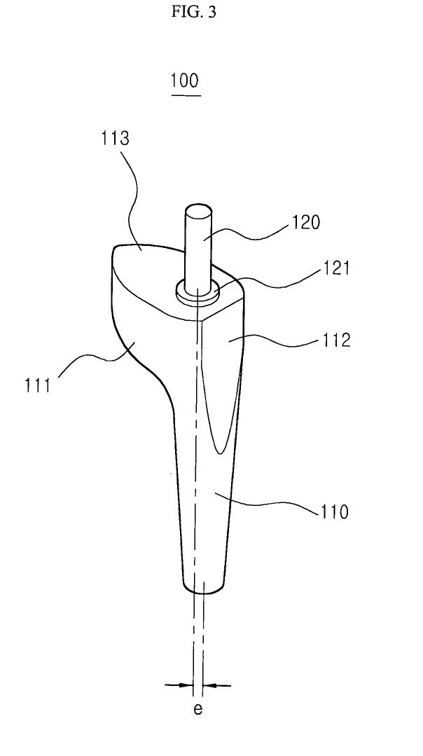

The fixing pin for a model teeth die 100 according to a preferred embodiment of the present invention, as shown in FIGS. 1 and 3, includes the die inserting portion 120 being connected to the model teeth die 20, and the model base inserting portion 110 being detachably connected to the model base 10.

The die inserting recess 21, in which the die inserting portion 120 of the fixing pin 100 is inserted, is formed on the bottom surface of the model teeth die 20. And, the model teeth die 20 is fixedly adhered to the die inserting portion 120 by any adhesive, etc.

The model base 10 is made of plaster, etc., as like gums of a person, and the model base inserting recess 11 is formed in the each position in which the model teeth die 20 will be connected. The model base inserting recess 11 is preferably formed so that the model base inserting portion 110 of the fixing pin 100 is fully inserted therein. Further, when the model base inserting portion 110 is inserted into the model base inserting recess 11, it is preferable that the exposed surface of the model base inserting portion 110 agrees with the surface of the model base 10.

Further, it is preferable that the model base inserting recess 11 is formed to be little bit larger than the model base inserting portion 110, so that the model teeth die 20 connected to the fixing pin 100 may be repeatedly connected to and disconnected from the model base inserting recess 11 having a shape corresponding to the model base inserting portion 110 of the fixing pin 100.

The fixing pin 100 of the present invention is made of a plastic material. Therefore, although the fixing pin 100 is repeatedly connected to and disconnected from the model base inserting recess 11 formed in the model base 10 made of plaster etc., the model base inserting recess 11 is not damaged due to the material of the fixing pin 100 being softer than that of the model base 10.

Further, the outer surface of the fixing pin 100 is worked to be smooth, therefore the fixing pin 100 may be easily connected to and disconnected from the model base inserting recess 11.

Hereinafter, the structure of the fixing pin 100 will be described in detail.

The fixing pin 100 includes the model base inserting portion 110 being connected to the model base 10 and the die inserting portion 120 being connected to the model teeth die 20.

The side expansion portion 111 is formed on the model base inserting portion 110 in order to expand to one side on the same line of the upper surface of the model base inserting portion 110.

It is preferable that the side expansion portion 111 is made of the same one as the material of the model base inserting portion 110. Further, it is preferable that the side expansion portion 111 is formed to be a streamline.

Further, the flat surface 112 having a predetermined length is formed on the other side of the model base inserting portion 110 being opposite to the side expansion portion 111.

Therefore, by virtue of the flat surface 112 and the streamlined side expansion portion 111, the fixing pin 100 is prevented from being rotated when it is inserted into the model base 11. Further, the fixing pin 100 may be easily connected to and disconnected from the model base 11.

The model base inserting portion 110 is a taper type in which one end thereof formed with the side expansion portion 111 has larger diameter than the other end thereof. This allows the insertion of the model base inserting portion 110 into the model base inserting recess 11 much more easily. Further, a technician may rotate the fixing pin 100 connected to the model teeth die in any desired directions when he/she works it since the model base inserting portion 110 is formed to be taper type.

In the present embodiment, although the model base inserting portion 110 is formed to be taper type, it can be a polygon such as a quadrangle. However, if the model base inserting portion 110 is manufactured as a polygon, it is relatively difficult to work the model base inserting recess 11 corresponding to the model base inserting portion 110 in the model base 10.

The die inserting portion supporting die 121 is formed on the upper surface of the model base inserting portion 110, and the die inserting portion 120 is formed thereon. However, it is possible that the die inserting portion 120 is directly formed on the model base inserting portion 110 without forming the die inserting portion supporting die 121.

It is preferable that the die inserting portion 120 is formed to be eccentric with the model base inserting portion 110. Thereby, a coupling force corresponding to the distance “e” is required to rotate the die inserting portion 120 with respect to the model base inserting portion 110. Therefore, the die inserting portion 120 may not be rotated until an outer force corresponding to the coupling force is applied therein. That is, when the die inserting portion 120 is inserted into the model base 10 and the model base inserting portion 110 is inserted into the model teeth die 20, the model teeth die 20 is not rotated until the outer force is applied to the model teeth die 20.

Further, it is preferable that the die inserting portion 120 is formed to be cylindrical as same as the model base inserting portion 110. However, like the model base inserting portion 110, the die inserting portion 120 may be formed to be a polygon such as a quadrangle. However, it is preferable that a sectional area of the die inserting portion 120 is formed to be smaller than that of the model base inserting portion 110.

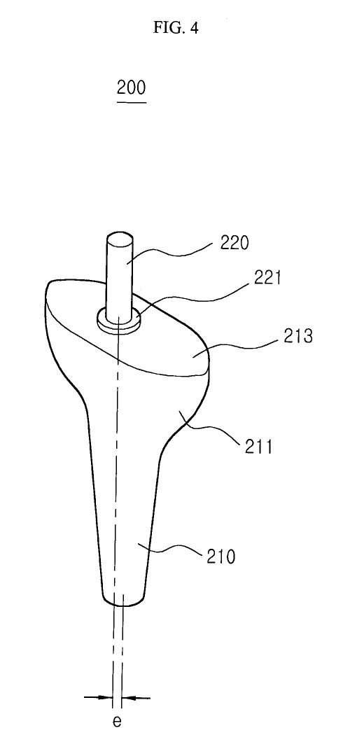

Next, the fixing pin for a model teeth die 200 according to another preferred embodiment of the present invention will be described referring to FIG. 4.

The fixing pin 200 includes the model base inserting portion 210 and the die inserting portion 220.

The model base inserting portion 210 is a taper type, and a streamlined side expansion portion 211 is formed on both sides thereof on the same line as the upper surface thereof. In the present embodiment, unlike the above-described embodiment, the side expansion portion 211 is formed on both sides of the upper portion of the model base inserting portion 210. Therefore, it is preferable that the model base inserting recess being formed in the model base is formed to correspond to the side expansion portion 211. Accordingly, when the model teeth die 20 is connected to the model base 10 by the fixing pin 200, it is prevented from being rotated.

A cylindrical die inserting portion 220 is formed on the upper side of the model base inserting portion 210, and the die inserting supporting die 221 is formed therebetween. However, as above-described, the die inserting portion 220 may be directly formed on the upper surface of the model base inserting portion 210 without forming the die inserting portion supporting die 221.

Further, the die inserting portion 220, as above-described, is formed to be eccentric against the model base inserting portion 210 at distance “e”.

According to the fixing pin for a model teeth die of the present invention, the die inserting portion being inserted into the model teeth die and the model base inserting portion being inserted into the model base are formed integrally. Therefore, the fixing pin for a model teeth die may be easily manufactured and the manufacturing cost may be saved.

Further, the model base inserting portion of the fixing pin is directly inserted into the model base inserting recess formed in the model base, therefore the manufacturing process becomes simplified.

Further, the fixing pin is made of a softer material than that of the model base. Therefore, although the model teeth die is repeatedly connected to and disconnected from the model base, the model base is not damaged.

Further, the model base inserting portion of the fixing pin is formed in a taper type, therefore the fixing pin may easily be inserted into the model base inserting recess formed in the model base.

Further, the fixing pin has a side expansion portion and a flat surface, therefore the model teeth die is prevented from being rotated when it is connected to the model base.

While the present invention has been particularly shown and described with reference to particular embodiments thereof, it will be understood by those skilled in the art that various changes in form and details may be effected therein without departing from the spirit and scope of the invention as defined by the appended claims.

1. A fixing pin for a model teeth die comprising:
a model base inserting portion for preventing a model teeth die from being rotated and for connecting said model teeth die to said model base; and
a die inserting portion connected to said model base inserting portion and being connected to said model teeth die.

2. The fixing pin as claimed in claim 1, wherein said model base inserting portion is provided with more than a side expansion portion on the outer periphery surface thereof for preventing said model teeth die from being rotated.

3. The fixing pin as claimed in claim 1, wherein said model base inserting portion is provided with a side expansion portion and a flat surface to be opposite on the outer periphery surface thereof for preventing said model teeth die from being rotated.

4. The fixing pin as claimed in claim 1, wherein said model base inserting portion is provided with more than a pair of side expansion portions to be opposite each other on the outer periphery surface thereof for preventing said model teeth die from being rotated.

5. The fixing pin as claimed in claim 2, wherein said side expansion portion is formed to be a streamline.

6. The fixing pin as claimed in claim 3, wherein said side expansion portion is formed to be a streamline.

7. The fixing pin as claimed in claim 4, wherein said side expansion portion is formed to be a streamline.

8. The fixing pin as claimed in claim 1, wherein said model base inserting portion and said die inserting portion are made of plastic materials.

9. The fixing pin as claimed in claim 1, wherein said model base inserting portion and said die inserting portion are formed to be eccentric to each other.

10. The fixing pin as claimed in claim 1, wherein said model base inserting portion is formed to be taper type.
